(19) United States
(12) Patent Application Publication
(10) Pub. No.: US 2024/0418036 A1
(43) Pub. Date: Dec. 19, 2024

(54) CORDLESS CURTAIN AND GUIDE BRAKING UNIT THEREOF

(71) Applicants: Hsien-Te HUANG, Taipei City (TW); Yu-Wei HUANG, Taipei City (TW)

(72) Inventors: Hsien-Te HUANG, Taipei City (TW); Yu-Wei HUANG, Taipei City (TW)

(21) Appl. No.: 18/741,327

(22) Filed: Jun. 12, 2024

(30) Foreign Application Priority Data
Jun. 16, 2023 (TW) 112206146

(51) Int. Cl. E06B 9/324

(52) U.S. Cl. CPC E06B 9/324

(57) ABSTRACT

The present invention provides a cordless curtain and guide braking unit thereof, wherein the guide braking unit includes a fixing mount and a round rod shaped metal wire that is wound round to form a slide sheering member. The fixing mount is configured with a bottom block, and a pull cord through hole is provided in the center of the surface thereof. The slide sheering member is provided with a circular through-hole and fastening rod members, wherein the circular through-hole is axially positioned corresponding to the pull cord through hole, with the fastening rod members fixed to two sides of the circular through-hole. The inner circular edge of the circular through-hole is used to provide the pull cord with cornering slippage, which protects the various system components and produces the desired damping effect.

### BACKGROUND OF THE INVENTION

### (a) Field of the Invention

The present invention relates to a cordless curtain and guide braking unit thereof, and more particularly to a curtain comprising horizontal slats with no exposed pull cord, wherein a guide braking unit is used to guide and brake the internal pull cord.

### (b) Description of the Prior Art

To ensure safe usage of curtains, curtains without exposed pull cords have been developed, which use a spring motor formed from a winding and unwinding mechanism to obtain a feedback force, whereby during the process of pulling down a lower rail at the curtain hem of the curtains, the energy from a pull-down motive force on the internal pull cords is transmitted and stored in an internal spring of the winding-unwinding mechanism through a winding-unwinding wheel. And during the operation of retracting the curtain upwards, the arms of a user first upwardly sets in motion the lower curtain hem to eliminate static friction of the curtain system, after which the energy stored by the spring inside the winding and unwinding mechanism effects a feedback output via the pull cords to retract and pull the lower rail upwards, thereby achieving a self-contained take-up curtain function of a self-retracting curtain.

Referring to FIG. 1, which shows a damping unit of the prior art, wherein a pull cord is used to raise and lower curtain slats by means of a spring motor 70, whereby the pull cord passes over steering damper rods 2131 of a guide braking unit 20, and then connects to curtain slats. In this cord configuration, the pull cord is hidden in the slats and an upper rail comprising a winding-unwinding mechanism, and cannot be seen from the outside. Accordingly, such a curtain system is commonly referred to as a cordless curtain.

The steering damper rods 2131 are usually fixed and not rotatable, providing a damping capacity in addition to having a cord steering guidance function.

The guide braking unit 20 guides the direction of a pull cord S1 connected to the spring motor 70 and is transversely installed with the at least one steering damper rod 2131, which enables the pull cord S1 to wind therearound to change the direction thereof and generate a primary side friction damping. In one embodiment of the prior art, if a higher damping value is required, after winding round the steering damper rod 2131, the pull cord S1 then winds round another steering damper rod 2131 on a corresponding side opposite to the first steering damper rod 2131, to enable generating a secondary cumulative damping effect. Finally, because the pull cord S1 needs to hang down to link together curtain slats 50, thus, the pull cord S1 needs to turn direction and be lowered from the center of a bottom block 212 by passing through an admittance hole 11 provided in an upper beam 10 corresponding to the hole position in the center of the bottom block 212.

This turning in direction of the pull cord S1 relies on the cornering sheering of a to-and-fro opening 61 provided in a riveted ring 60 that is coaxially encased in a through hole 24 positioned in the center of the bottom block 212, thereby preventing direct friction between the lip, made of plastic or metal, of the through-hole 24 and the pull cord S1 being pulled therethrough. The lower end of the riveted ring 60 is coaxially embedded inside the circular space of the admittance hole 11.

In the prior art, the riveted ring 60 enabling the pull cord S1 to corner and sheer thereover is a primary thin metal tube, which is coaxially riveted to the through hole 24 provided in the bottom block 212.

As a result of the riveted ring 60 being riveted to the through hole 24 (as shown in FIG. 2), the basic form of the riveted ring 60 is preshaped from a thin metal tube with a slip lip opening 62. After the lower end of the thin metal tube passes through the depth of the through hole 24, a spread crimping operation is carried out on the lower end thereof, forming split braids 66 that inverse clasp to the lower end edge of the through hole 24.

The method used to form the split braids 66 involves expanding the lower end opening of the riveted ring 60 to produce cracks 64 therein using a jig at the beginning of a crimp riveting operation, and then causing the plurality of cracks 64 to split and form the split braids 66.

The split braids 66 are then bent to form inverse clasps that clamp onto the edge of the through hole 24, thereby achieving coaxial joining of the riveted ring 60 and the through hole 24.

During the expansion operating procedure, because the riveted ring 60 is made from thin metal material, split openings 63 are liable to spread out due to radial expansion, and due to the extent of the excessive widening of the extended axial cracks 64, there is a good chance that a crack end portion 65 will upwardly extend, first entering the wall of the to-and-fro opening 61, then extending to enable slide sheering contact of the pull cord S1 with the slip lip opening 62. Moreover, because the body wall of the round tube has split cracks, preexisting formed stresses on the cracks 64 (the crack end portion 65) result in unbalanced forces and separate deformations occurring, which cause respective corresponding two cracks on two sides of the cracks 64 or the crack end portion 65, forming different drop heights in the enclosed ring surface, and causing corresponding cracked edges to form protruding or sunken sharp edges.

Under the above-described circumstances, when the slide sheering cord body of the pull cord S1 is operating, generally, excessive extension of the crack end portion 65 or the respective sharp edges formed on the cracks 64 results in scuffing and breaking of the pull cord S1 occurring. And because the riveted ring 60 is formed by punching thin metal, If the pull cord S1 is thick, after a certain period of time, cuts will form thereon due to sliding friction.

Referring to FIG. 2-1, which shows a related system damping, which apart from the above-described conflagration, a pair of the steering damper rods 2131 are additionally horizontally positioned directly above the through hole 24 of the bottom block 212, which are used to guide the routing direction of the pull cord S1 to a transverse direction, thereby enabling the pull cord S1, after cornering over the steering damper rods 2131, to pass through the through hole 24 and hang down.

The through hole 24 is similarly coaxially riveted with the above-described riveted ring 60. and the cracks 64 and the extended crack end portion 65 are similarly produced on the inner ring wall of the to-and-fro opening 61 and the slip lip opening 62 of the riveted ring 60.

The pull cord S1 passes over the corresponding circumferential surfaces of the steering damper rods 2131, and under the effect of an external force, the cord body of the pull cord S1 will not be fixedly positioned on the longitudinal surfaces of the steering damper rods 2131 and waver thereon. When the pull cord S1 deviates from the vertical projected area range of the inner circumference of the to-and-fro opening 61, then the cord body of the pull cord S1 will rub against the inner circumference surface of the to-and-fro opening 61, and with the addition of the extant cracks on the to-and-fro opening 61, the surface of the passing cord body of the pull cord S1 is liable to being cut.

### SUMMARY OF THE INVENTION

The present invention is fitted with a metal wire wound round and formed as an integral body, which together with a slide sheering member provided with a damping effect are stably positioned on the bottom portion of a guide braking unit, enabling safe slide sheering of a pull cord and providing the required damping function.

The guide braking unit comprises a fixing mount and the slide sheering member, wherein the fixing mount comprises a bottom block and a pair of side walls. The pair of side walls are respectively connected to the two sides of the bottom block, and the center of the bottom block is internally provided with a pull cord through hole.

The slide sheering member is fixed to the upper portion or the lower portion of the bottom block and coaxially corresponds to the pull cord through hole. Fastening rod members connect to two sides of a circular through-hole.

The present invention further provides a cordless curtain, comprising an upper beam, a plurality of curtain slats configured below the upper beam, a pair of guide braking units, which are fixed to the two internal sides of the upper beam; and a pair of angle controllers, which are respectively positioned at the sides of the guide braking units inside the upper beam. Each of the guide braking units comprises the fixing mount, a ladder cord suspending hub, and the slide sheering member.

If the system requires a light damping effect, the slide sheering member of the present invention directly enables the pull cord configured to a spring motor to turn downward and link up with the curtain slats, to form a primary cornering and one-time light value damping effect.

If the system requires a higher damping effect, one or more steering damper rod(s) can be additionally fitted to each of the guide braking units in the direction receiving the pull cord, thereby enabling primary or more than two-time cornering of the pull cord inside each of the guide braking units, to form at least two cornering cumulative damping values in conjunction with the slide sheering member.

To enable a further understanding of said objectives, structures, characteristics, and effects, as well as the technology and methods used in the present invention and effects achieved, a brief description of the drawings is provided below followed by a detailed description of the preferred embodiments.

### BRIEF DESCRIPTION OF THE DRAWINGS

FIG. 1 is a configurational view of a damping unit of the prior art.

FIG. 2 is a three-dimensional schematic view of a riveted ring of the prior art.

FIG. 2-1 is a three-dimensional schematic view of a wire passing through the riveted ring of the prior art.

FIG. 3 is a three-dimensional view of a cordless curtain of the present invention.

FIG. 4 is an exploded view of a guide braking unit of the present invention.

FIG. 5 is another exploded view of the guide braking unit of the present invention.

FIG. 6 is a three-dimensional assembled view of the guide braking unit of the present invention.

FIG. 7 is another three-dimensional assembled view of the guide braking unit of the present invention.

FIG. 8 is a top view depicting application of a slide sheering member according to the present invention.

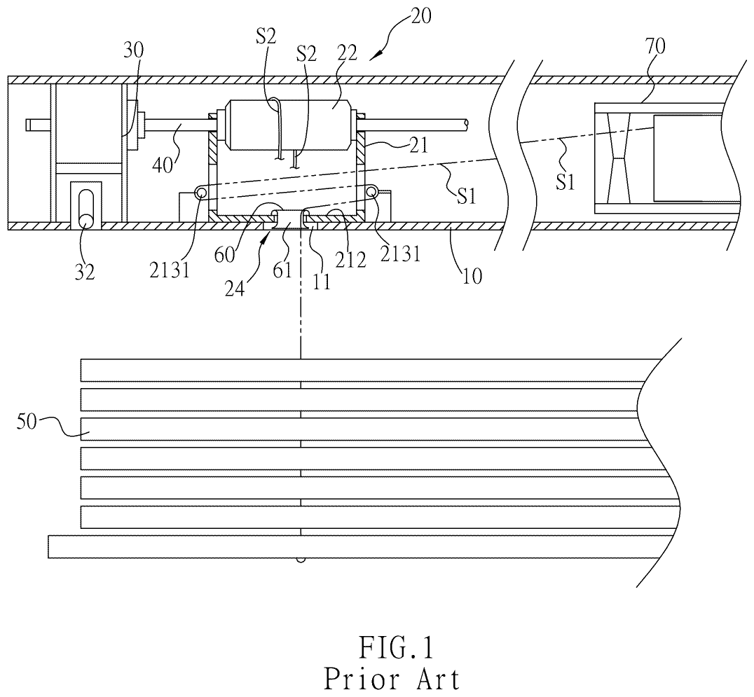

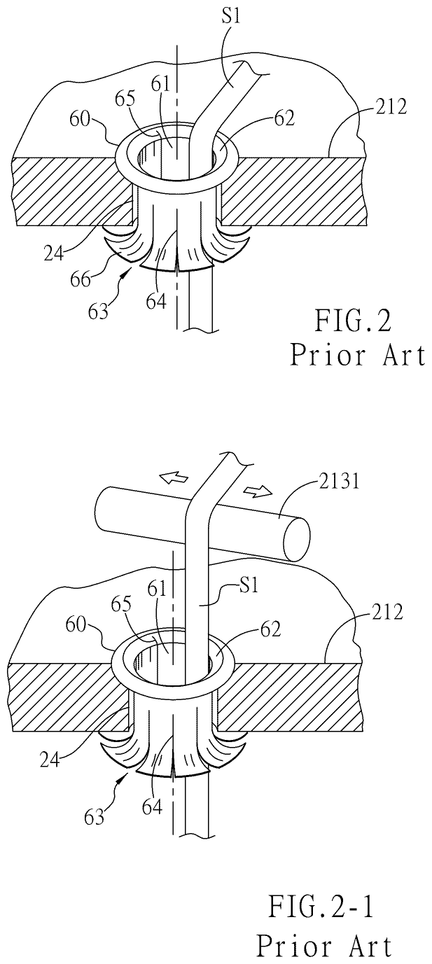

### DETAILED DESCRIPTION OF THE PREFERRED EMBODIMENTS

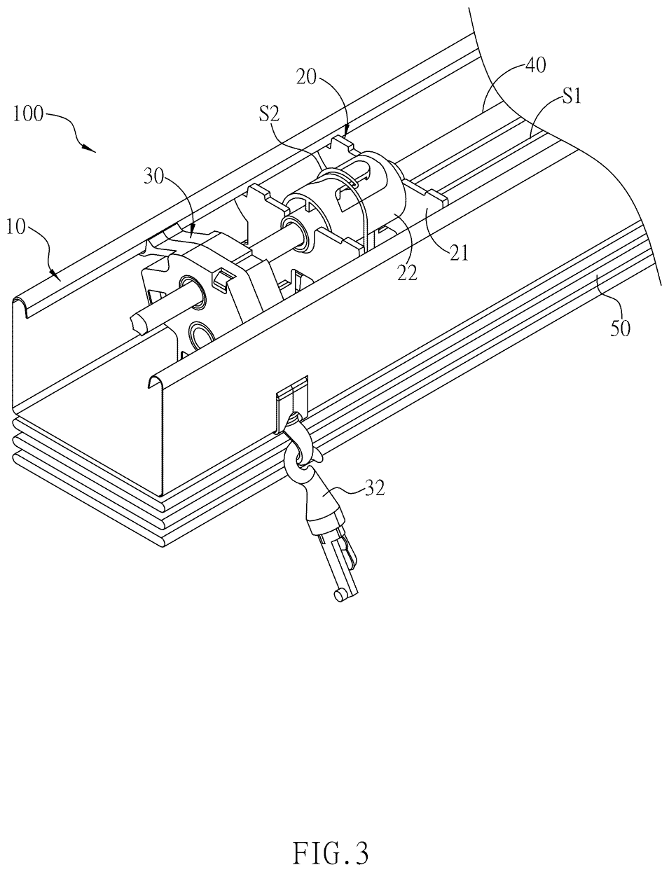

Regarding the embodiments of the present invention, first refer to FIG. 3, which shows a cordless curtain and guide braking unit thereof of the present invention, wherein a cordless curtain 100 comprises an upper beam 10, a plurality of curtain slats 50 configured below the upper beam 10, a pair of guide braking units 20 fixed to the interior of the upper beam 10, and a pair of angle controllers 30, which are respectively positioned at the sides of the guide braking units 20. FIG. 3 only shows one of the guide braking units 20 and one of the angle controllers 30 for reference; the other end of the upper beam 10 is installed with the other guide braking unit 20 and the other angle controller 30. Furthermore, FIG. 3 omits a winding-unwinding mechanism.

A portion of each of the angle controllers 30 extends to the exterior of the upper beam 10 and connects to a rotating member 32. A ladder cord S2 is wound around a ladder cord suspending hub 22 of the guide braking unit 20, and the ladder cord S2 passes downward through the guide braking unit 20 and the upper beam 10, connecting to the curtain slats 50. Rotating the rotating member 32 drives a gear wheel (not shown in the drawings) inside the angle controller 30, which drives a linkage rod 40, which then rotates the ladder cord suspending hub 22 of the guide braking unit 20, thereby pulling the ladder cord S2 and adjusting the angle of the curtain slats 50.

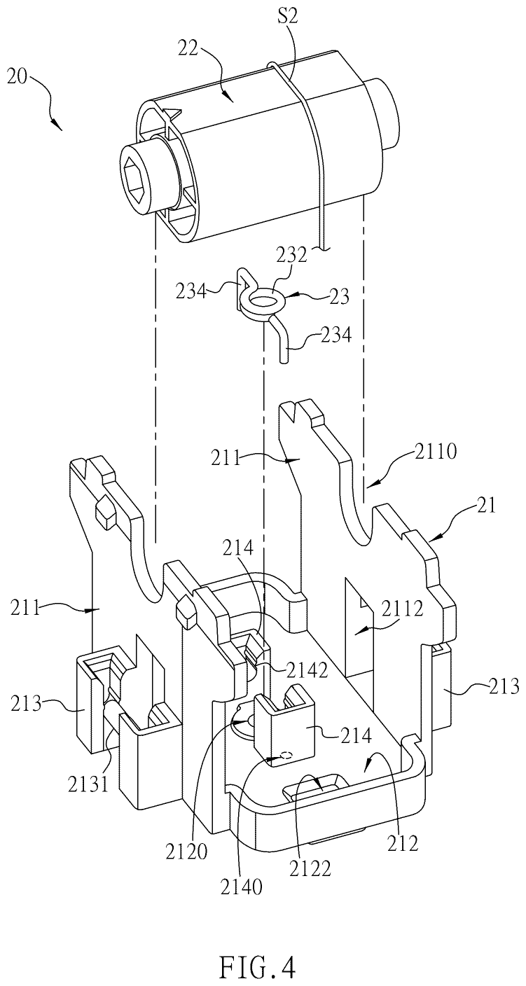

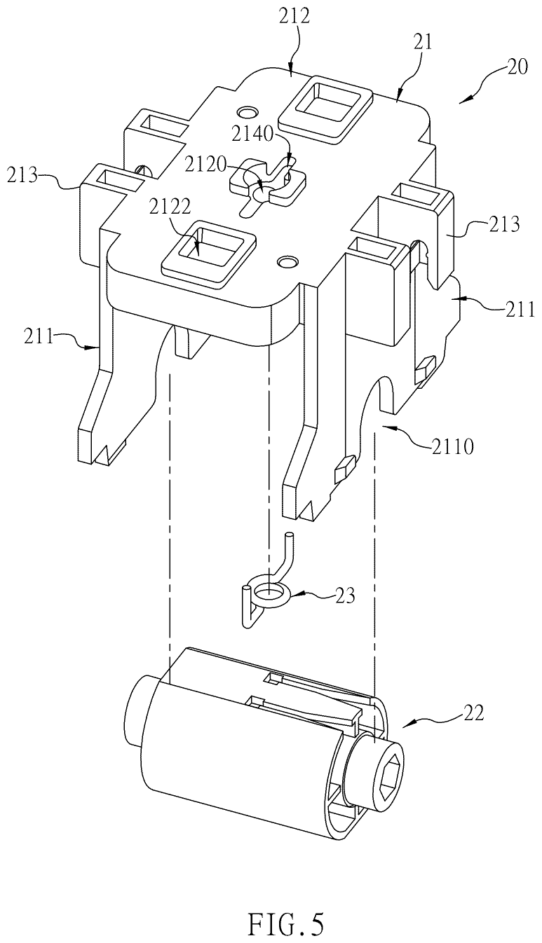

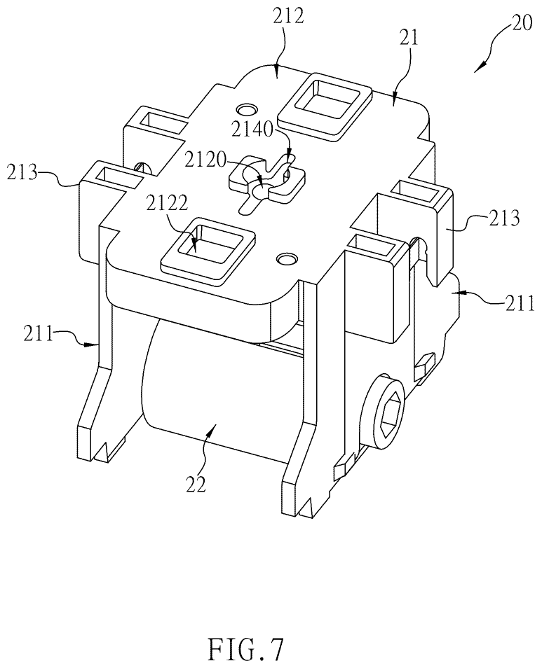

Referring to FIGS. 4 to 7, which show the guide braking unit 20 comprising a fixing mount 21, the ladder cord suspending hub 22, and a slide sheering member 23.

The fixing mount 21 is roughly U-shaped, and comprises a bottom block 212 and a pair of side walls 211, which are respectively connected to the two sides of the bottom block 212. A pull cord through hole 2120) is provided in the bottom block 212 close to the central portion thereof, and the pair of side walls 211 of the fixing mount 21 are wedged inside the upper beam 10.

The ladder cord suspending hub 22 is rotatable configured to the pair of side walls 211. More specifically, a pin connecting indentation 2110 is formed in each of the side walls 211, and the two ends of the ladder cord suspending hub 22 are respectively rotatable pivoted on the pin connecting indentations 2110.

The slide sheering member 23 is fixed to the bottom block 212, wherein the slide sheering member 23 is provided with a circular through-hole 232 and fastening rod members 234. The circular through-hole 232 is positioned on the pull cord through hole 2120 of the bottom block 212, and the fastening rod members 234 connect to the two sides of the circular through-hole 232. The fastening rod members 234 extend toward the bottom block 212 and are fixed to two sides of the circular through-hole 232.

The slide sheering member 23 of the present embodiment is formed as an integral body by bending and winding round a metal wire with a circular cross-section. And the above-described fastening rod members 234 are respectively connected in a winding configuration to two opposite sides of the circular through-hole 232 through the center point thereof.

The fixing mount 21 further comprises a pair of socket bases 214, which are respectively positioned on two sides of the pull cord through hole 2120, and the above-described pair of fastening rod members 234 are respectively insertedly fixed to the pair of socket bases 214, thereby completing the assembly. More specifically, the fastening rod members 234 assume L shapes, and each of the socket bases 214 upwardly assumes a U-shape, as well as forming plug holes 2140 that are perpendicular to the bottom block 212. A stopping portion 2142 is formed on the two inner side surfaces of each of the socket bases 214. Portions (or so called horizontal sections) of the fastening rod members 234 of the slide sheering member 23 parallel to the bottom block 212 are wedged into the stopping portions 2142; and portions (or so called vertical sections) of the fastening rod members 234 perpendicular to the bottom block 212 are respectively inserted into the plug holes 2140, wherein the plug holes 2140 pass through the bottom surface of the bottom block 212. Hence, in another embodiment of the slide sheering member 23, the slide sheering member 23 can downwardly penetrate the plug holes 2140 through to the bottom surface of the fixing mount 21, thereby enabling the fastening rod members 234 to penetrate and be clasped to the bottom surface of the fixing mount 21 from the bottom upwards.

As a supplementary description, the bottom block 212 of the fixing mount 21 is further provided with a pair of outer cord holes 2122, which are respectively positioned to the sides of the above-described pair of socket bases 214 at a distance thereto. The ladder cord S2 is wound around the ladder cord suspending hub 22, and then downwardly passes through the pair of outer cord holes 2122 of the bottom block 212.

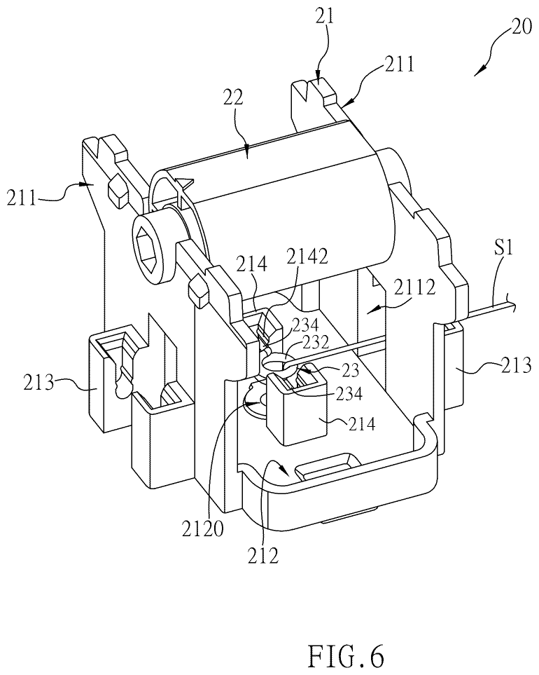

An opening 2112 and a side axle seat 213 is formed in each of the side walls 211 of the fixing mount 21, wherein the openings 2112 roughly assume a rectangular shape, and each of the side axle seats 213 is configured with a steering damper rod 2131 that enables a pull cord S1 to wind therearound (see FIG. 6).

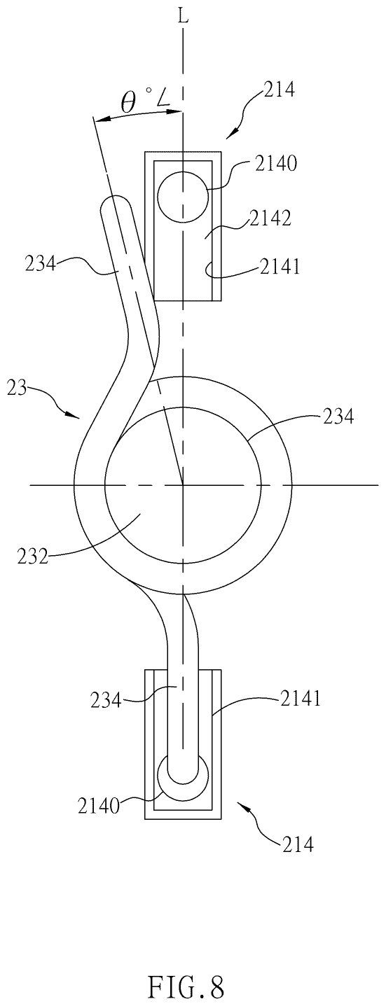

Referring to FIG. 8, the slide sheering member 23 is made from a metal wire with a circular cross-section, wherein the wire can be further provided with elastic stress. The two fastening rod members 234 of the formed slide sheering member 23 extend outward from the outer circumference of the circular through-hole 232 on two sides thereof, outwardly extending in opposite directions from two sides of the slide sheering member 23 corresponding to a line L through the center of the circular through-hole 232, wherein a plane angle between the extended directions forms a deflection prestress angle θ, enabling the two fastening rod members 234 of the slide sheering member 23 to be respectively aligned and assembled in the two plug holes 2140. After being assembled, an elastic counteracting force generated when the prestress angle θ is changed is stopped by the rod body of each of the fastening rod members 234 pressing against a contiguous elevation 2141 configured on each of the stopping portions 2142. The contiguous elevations 2141 are at the same angle of orientation to the corresponding line L, wherein the contiguous elevations 2141 and the plug holes 2140 enable the fastening rod members 234 to be assembled and fixed therein, after which the elastic stress of the prestress angle θ is used to generate a planar snap force, which causes the slide sheering member 23 to be elastically pressed against and stably positioned in the socket bases 214. Moreover, the elastic stress is used to absorb the vibrations generated by the crossing-over movement of the pull cord S1.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. A cordless curtain and guide braking unit, comprising:
a fixing mount, comprising a bottom block and a pair of side walls, which are respectively connected to two sides of the bottom block, and the bottom block is provided with a pull cord through hole;
a slide sheering member made from metal wire with a circular cross-section, which is formed as an integral body with a circular through-hole and a pair of fastening rod members that outwardly extend in opposite directions on two sides of the circular through-hole, wherein the circular through-hole is coaxially positioned corresponding to the pull cord through hole; the fastening rod members are insertedly fixed to the two sides of the circular through-hole provided in the bottom block.

2. The cordless curtain and guide braking unit according to claim 1, wherein the fixing mount further comprises a pair of socket bases, which are respectively positioned on two sides of the pull cord through hole, and the pair of fastening rod members are respectively insertedly fixed to the pair of socket bases.

3. The cordless curtain and guide braking unit according to claim 2, wherein ends of the fastening rod members assume L shapes, and each of the socket bases upwardly assumes a U-shape, as well as forming plug holes that are perpendicular to the bottom block; a stopping portion is formed on two inner side surfaces of each of the socket bases; portions of the fastening rod members of the slide sheering member parallel to of the bottom block are wedged into the stopping portions, and portions of the fastening rod members perpendicular to the bottom block are inserted into the plug holes.

4. The cordless curtain and guide braking unit according to claim 3, wherein the plug holes pass through a bottom surface of the bottom block.

5. The cordless curtain and guide braking unit according to claim 1, wherein the pair of fastening rod members extend outward in opposite directions from two sides of the slide sheering member corresponding to a line therethrough, a plane angle between extended directions forms a deflection prestress angle.

6. A cordless curtain, comprising:
an upper beam;
a plurality of curtain slats, which are configured on a lower side of the upper beam;
a pair of guide braking units, which are fixed inside the upper beam; and
a pair of angle controllers, which are respectively positioned at the sides of the pair of guide braking units; wherein the guide braking unit comprises:
a fixing mount, which comprises a bottom block and a pair of side walls, which are respectively connected to two sides of the bottom block, the bottom block is provided with a pull cord through hole; a ladder cord suspending hub, which is rotatable configured to the pair of side walls; and a slide sheering member made from metal wire with a circular cross-section wound round and formed as an integral body, which is fixed to the bottom block; the slide sheering member is integrally formed with a circular through-hole and a pair of fastening rod members, wherein the circular through-hole is positioned on an upper side of the pull cord through hole, and the fastening rod members connect to two sides of the circular through-hole.

7. The cordless curtain according to claim 6, wherein the slide sheering member is made from metal wire wound round and formed as an integral body; the fastening rod members are respectively bent and connected to side portions of the circular through-hole.

8. The cordless curtain according to claim 6, wherein the fixing mount further comprises a pair of socket bases, which are respectively positioned on two sides of the pull cord through hole, and the pair of fastening rod members are respectively insertedly fixed to the pair of socket bases.

9. The cordless curtain according to claim 6, wherein the plug holes pass through a bottom surface of the bottom block.

10. The cordless curtain according to claim 6, wherein the pair of fastening rod members extend outward in opposite directions from two sides of the slide sheering member corresponding to a line therethrough, a plane angle between extended directions forms a deflection prestress angle.
